(19) United States
(12) Patent Application Publication
(10) Pub. No.: US 2006/0169027 A1
(43) Pub. Date: Aug. 3, 2006

(54) Apparatus for accurately measuring permeation rates through polymeric pipes and uses thereof

(76) Inventor: Robert B. Fish JR., Parkersburg, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/331,691

(22) Filed: Jan. 13, 2006

Related U.S. Application Data
(60) Provisional application No. 60/643,900, filed on Jan. 14, 2005.

(51) Int. Cl. G01N 15/08

(52) U.S. Cl. 73/38

(57) ABSTRACT

There is provided apparatus for measuring the permeation of liquid organic compounds within polymeric pipe. The apparatus includes flanges positioned at the open ends of the pipe, appropriately secured and incorporating gaskets to seal the liquid organic compounds within the pipe. Elements for filling the pipe within the assembly are also disclosed.

### FIELD OF THE INVENTION

The present invention relates to apparatus useful for measuring the permeation rate of fluids through polymeric pipes and the use of such apparatus. More particularly the present invention relates to apparatus designed to secure specimens of polymeric pipes with minimal distortion of their surfaces, to effectively charge the specimen with fluid and to seal the specimen at its ends, and to facilitate accurate measurements of the permeation rate of liquids and vapors therethrough.

### BACKGROUND OF THE INVENTION

Accurately measuring the permeation rates in polymeric pipes is increasingly a matter of significant commercial importance. This is because new, high performance polymeric pipes are being developed to carry a wide variety of liquid organic compounds. These polymeric pipes frequently enjoy significant benefits over their metal counterparts with respect to enhanced corrosion resistance, the ability to be placed on coils for shipment and storage before use, and ease of manufacture. However, polymers are to varying degrees permeable to such liquid organic compounds. Because liquid organic compounds that permeate through the pipes would then enter the surrounding environment, manufacturers are striving to produce pipes that feature lower and lower permeation rates, so that lesser amounts of liquid organic compounds are released into the environment.

Precisely measuring the permeation rates becomes increasingly difficult as lower and lower permeation rates are encountered. Even very small leaks from the testing apparatus can easily ruin a test by falsely indicating high permeation rates. Because some permeation rates are so low, very long test times will be involved before equilibrium is achieved. Therefore, the financial incentive to avoid spoiled tests is increasing.

Previous techniques commonly used to measure permeation rely on the testing of flat substrates, and typically films have been used. One such method of measuring the permeation rates involves the use of a light-weight cup sealed at the top with a sample of the test film. Such an approach often incorporates a well known permeation cup sold by the Thwing-Albert Instrument Company, Philadelphia, Pa. Thwing-Albert permeation cups are very useful for measuring the permeation rates in sheet materials, including polymeric sheets. These cups are light weight cups with a sealing mechanism. The liquid organic compound could be added to an open cup. The test sample would be placed across the top and the sealing top would be secured. Loss in weight over time and the exposed surface area would be noted to measure permeation rate. Various industry standards incorporate the use of this test method, including ASTM E96-80. The difficulty is that the Thwing-Albert permeation cups and similar arrangements will accept only flat samples such as paper, film, cast sheet and injection molded flat parts. As they can only accept flat samples, they are not suitable for measuring permeation in pipes.

While testing techniques suitable for measuring permeation in or through pipes have been developed, such techniques typically incorporate heavy mechanical parts. This is because unlike films that can be wrapped or otherwise secured to a permeation cup, pipes define a cavity that must be sealed so that fluid loss during testing is due to permeation only as opposed to leakage from the testing apparatus. Therefore to accommodate pipes, testing apparatus must pass more rigorous design challenges. In particular, some apparatus currently in use rely on heavy plugs and the like to adequately seal the pipes during testing. However these plugs have the disadvantage of adding significant weight to the assembled and filled test apparatus, thereby reducing the accuracy of the test.

Another widely accepted approach today involves securing the open pipe ends with polymeric end caps such as the manufacturer might supply with their commercial product portfolio. However these polymeric end caps have the disadvantage of being permeable themselves. Therefore there will be some fluid losses through those caps. Further, use of the polymeric end caps makes a portion of the pipe irregular in total thickness, thereby further complicating the calculation of the true permeation rate during the test.

It is an object of the present invention to provide apparatus for measuring of permeation associated with polymeric pipes, and in a way that avoids the use of heavy plugs that might be inserted into the pipe. It is a further object of the present invention to provide such apparatus which also avoids the use of polymeric end caps These and other objects, features, and advantages of the present invention will become better understood upon having reference to the description of the invention herein.

### SUMMARY OF THE INVENTION

There is disclosed and claimed herein apparatus useful in determining the permeation rate of liquid organic compounds through polymeric pipes, comprising:
(a) A first flange and a second flange located opposite one another with the polymeric pipe positioned therebetween;
(b) said flanges each having opposing indented surfaces and with gaskets secured within said indented surfaces, such that said gaskets extend partially outside said indented surfaces and said gaskets further engage opposing ends of the polymeric pipe, and further said first and second flanges are secured to the pipe; and
(c) said first flange and associated gasket having an aperture formed therethrough and closure means to accommodate the introduction of liquid organic compounds and retain them within the pipe.

The invention will become better understood upon having reference to the drawing in connection with this application.

### BRIEF DESCRIPTION OF THE DRAWINGS

FIG. 1 provides a side view (b) and end views (a) and (c) of the top and bottom ends of the apparatus of the invention.

### DETAILED DESCRIPTION OF THE INVENTION

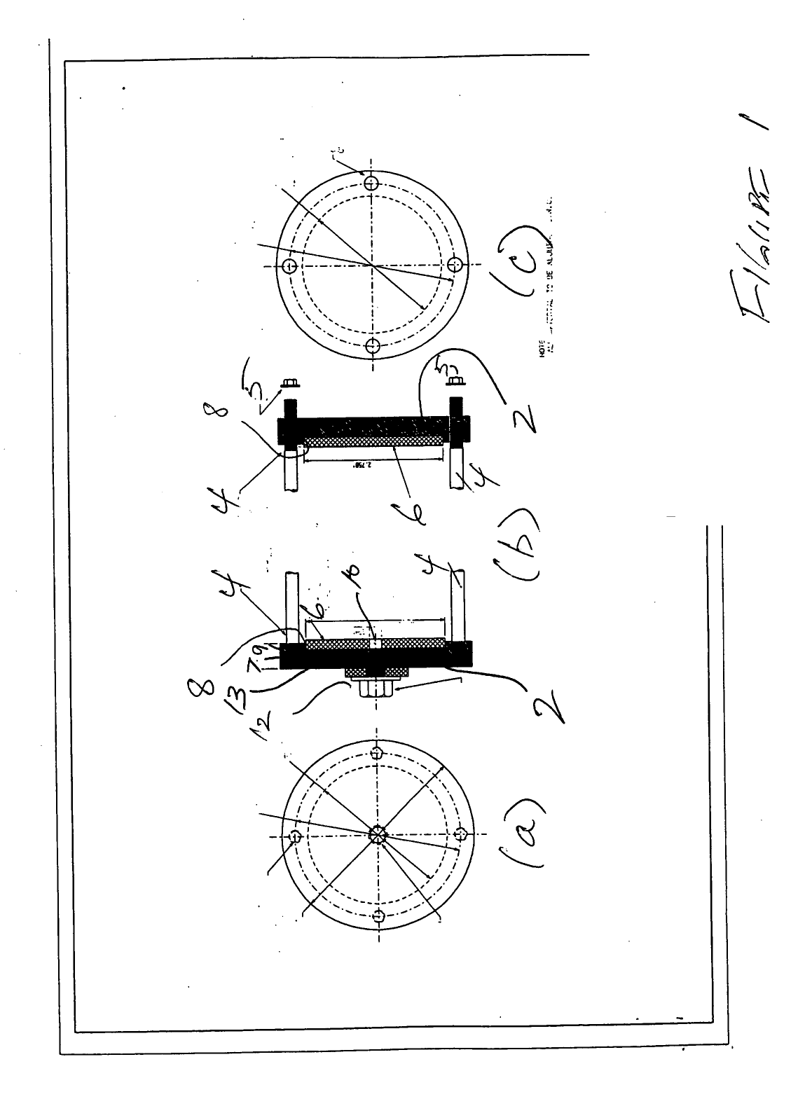

Having reference to FIG. 1, the apparatus consists of two blind flanges 2 and a plurality of bolts 4 (as shown, four bolts are used with steel flange nuts 5) that may be used to force the flanges 2 together against the test pipe specimen. In this depiction, one of the blind flanges 2 has an aperture formed therethrough to accommodate the bolts 4 while the other blind flange 2 has a threaded recessed area 7 to receive the threaded bolt ends 9. It will be noted a gasket 6 opposing the pipe sample is in each of the blind flanges. The gasket 6 is recessed into the flange 2 at indentations 8 formed within the surface of the flange 2. By tightening the bolts 4, the open ends of the pipe may be pressed into the gasket 6, thereby creating a seal for the apparatus which serves the additional benefit of securing the pipe to the flanges 2 and gasket 6. Of course, it will be apparent that various materials would be appropriate for the gasket 6, but they will vary depending on which liquid organic compound is being tested. Gaskets of Viton® perfluoroelastomer available from E.I. DuPont de Nemours & Co., Inc. of Wilmington, Delaware are especially preferred. One of the blind flanges 2 is also equipped with an opening 10 and a closure 12 for adding the liquid organic compound once the apparatus has been assembled.

The size of the flanges 2 would depend on the size of the pipe being tested. The flange must be large enough to completely seal the ends of the pipe. However, they should be no larger than necessary, as unnecessarily large or thick flanges will increase the weight of the assembled apparatus, thereby decreasing the accuracy of the test.

The size of the gasket 6 would also depend on the dimensions of the pipe being tested. It must be of sufficient size to completely cover the ends of the pipe section being tested, although it could be made larger to accommodate a variety of pipe diameters. Prior to beginning a test, the test operator should carefully inspect the gasket and replace it if it has become stiff, cut, or otherwise deteriorated.

To use the apparatus, a test pipe specimen would be cut from a larger section of pipe. The ends of the pipe would be treated in an appropriate manner to provide a flat end surface perpendicular to the outer wall of the pipe. Many such methods would be well known to those skilled in the art and any could be used without departing from the spirit of this invention. Examples of such techniques would include cutting the saw using special blades designed for cutting plastic, sanding the ends, lapping the ends with a fine file, machining the ends with a milling machine or a combination using one or more of these techniques together with others.

The apparatus would then be assembled with the test section of pipe being placed between the two flanges 2 and compressed against the gasket 6 by tightening the four bolts 4. It will be appreciated by those having skill in this field that any of a variety of means of securing these elements together may be used so long as the pipe is not unnecessarily compressed or otherwise distorted in a way that would compromise the permeation of the polymeric material versus its relaxed state. These may include without limitation fastening the components together as by screws, clamps, glue, and the like. The bolts 4 should be tightened uniformly using a torque wrench to insure they are all equally tightened and to avoid crushing the test pipe sample.

The liquid organic compound would be added through the addition port (defined as the opening 10 and the closure 12). This could be accomplished using a syringe. Sufficient liquid organic compound should be added to last throughout the testing period but it must not be so much as to completely fill the apparatus. If the apparatus were completely filled, expansion of the liquid organic compound as temperature changes would overpressure the apparatus and result in fluid loss.

Examples of liquid organic compounds commonly used for this type test could be gasoline, model gasoline test fluids such as Fuel C or Fuel CE10 as described in ASTM D 471-98. Other liquid organic compounds could be methanol, ethanol, trichlorethylene, acetone, and toluene, and numerous others, and blends thereof. It is to be appreciated that other fluids can be accommodated in tests employing this apparatus, including without limitation water, ammonia, and aqueous solutions.

The materials of construction for the blind flanges 2 would also depend on the liquid organic compounds being tested. They could be an appropriate alloy of stainless steel or titanium, or aluminum. If otherwise suitable, aluminum is preferred owing to its light weight. Other metals could also be used as needed. It is essential that the flange 2 be resistant to the liquid organic compounds in use, and not allow permeation or leakage through or around the flange.

The closure for addition of the liquid organic compounds must be absolutely vapor tight. For example, leakage around the threads 12 or around the screwed cap could occur. Screwing the closure 12 into a threaded hold in the flange 2 and then welding it to the flange 2 can prevent leakage around the threads 13. The screwed cap can be selected of a leak proof design such as Swagelok male connector with cap. The potential for leakage can be further reduced by then sealing the cap with tape.

The test operator can verify that the apparatus is leak proof by assembling it with a metal pipe in the place of the polymeric pipe and weighing the apparatus daily for several weeks. No leakage should be detected, even using a highly accurate scale.

Following the assembly of the test apparatus, the total weight of the apparatus, test pipe, and liquid organic compounds should be noted over a period of time. Typically, the first few measurements will show negligible loss, as the pipe wall becomes saturated with the liquid organic compounds. Changes of weight in the first few days of the test could indicate leakage and would warrant inspection by the test operator. After the liquid organic compound has permeated all the way through the pipe, weight loss will begin to occur during the steady-state period of the test. This period may be days or months, depending on the permeation rate of the piping system involved. It is best to take readings at least daily until that individual test proves that a less frequent measurement interval would suffice. During the steady state period of the test, the test operator should expect that loss of a constant weight per day could occur. The steady state period of the test ends when one or more of the liquid organic compounds has become depleted. At that point, the curve will again flatten out, reflecting the permeation rate of the lower permeation materials.

With knowledge of loss rate during the steady state portion of the test, and the pipe surface area, the test operator can calculate the permeation rate.

### EXAMPLE

Apparatus as described in the detailed description above and as depicted in FIG. 1 was prepared using all aluminum materials. The gaskets were made of Viton® perfluoroelastomer and measured 2.75″ diameter and 0.1875″ thick, one with a ¼″ hole in the center. The gasket seated ⅛″ deep within each flange. The flange accommodating the bolts was prepared with 9/32″ diameter holes on 3.273″ diameter BC. The flange receiving the bolts was drilled and tapped at ⅜″ deep recesses. The opening for introduction of liquid organic compounds was 0.250″ in diameter and received a stainless steel cap 3/8-16 screw ⅜″ long. The rods (extension of the bolts) were each 5½″ long and with threads at each end of ⅜″ and 1″ in length.

A section of polyethylene pipe having a length of 109.0 mm, an outside diameter of 59.5 mm, and a wall thickness of 4.1 mm was obtained and placed between the two flanges of the apparatus described above. The pipe was secured in place by tightening the nuts on the end of the threaded rods. The cap for the opening for the introduction of liquid organic compounds was removed and and the pipe was filled to about 90 percent full with reagent grade hexane. A backing comprising a Vitron® gasket was added to the cap, which was then replaced and tightened. The entire assembled, filled apparatus was stored in a room having a temperature of about 23° C. The weight of the assembled, filled apparatus was determined and recorded daily except for on weekends and holidays. Weight determination was done using a Mettler Toledo PR8002 electronic balance. The measured weights are given in Table 1.

TABLE 1

| Day | Weight (g) |
|---|---|
| 1 | 851.68 |
| 2 | 851.71 |
| 5 | 851.67 |
| 6 | 851.68 |
| 7 | 851.69 |
| 8 | 851.67 |
| 9 | 851.67 |
| 13 | 851.65 |
| 14 | 851.66 |
| 15 | 851.66 |
| 16 | 851.66 |
| 19 | 851.62 |
| 20 | 851.63 |
| 21 | 851.64 |
| 22 | 851.60 |
| 23 | 851.61 |
| 26 | 851.49 |
| 27 | 851.42 |
| 28 | 851.38 |
| 29 | 851.34 |
| 30 | 851.24 |
| 33 | 851.07 |
| 34 | 850.99 |
| 35 | 850.94 |
| 36 | 850.86 |
| 37 | 850.82 |
| 40 | 850.64 |
| 41 | 850.53 |
| 42 | 850.46 |
| 43 | 850.39 |
| 44 | 850.33 |
| 47 | 850.16 |
| 48 | 850.05 |
| 49 | 850.01 |
| 50 | 850.01 |
| 51 | 849.86 |
| 54 | 849.63 |
| 55 | 849.55 |
| 56 | 849.51 |
| 57 | 849.41 |
| 58 | 849.35 |
| 61 | 849.11 |
| 62 | 849.04 |
| 63 | 848.95 |
| 64 | 848.87 |
| 65 | 848.78 |
| 68 | 848.58 |
| 69 | 848.51 |
| 70 | 848.36 |
| 71 | 848.30 |
| 72 | 848.25 |
| 75 | 847.98 |
| 76 | 847.92 |
| 77 | 847.83 |
| 78 | 847.71 |
| 79 | 847.63 |
| 82 | 847.38 |
| 83 | 847.30 |
| 84 | 847.22 |
| 85 | 847.08 |
| 86 | 847.00 |
| 89 | 846.75 |
| 90 | 846.66 |
| 91 | 846.57 |
| 96 | 846.12 |
| 97 | 846.01 |
| 98 | 845.92 |
| 99 | 845.83 |
| 100 | 845.74 |
| 103 | 845.50 |
| 104 | 845.39 |
| 105 | 845.33 |
| 106 | 845.22 |
| 107 | 845.12 |
| 110 | 844.86 |
| 110 | 844.78 |
| 112 | 844.69 |
| 113 | 844.62 |

From the data in Table 1 it can be seen that the weight remained relative constant from Day 1 until about Day 21. This indicates the absence of leakage of the hexane from around the seals at both ends of the pipe sample and the absence of leakage around the cap. The data further indicate that from about Day 47 until the end of the test on Day 113 there was a period of steady weight loss averaging about 0.08 g/day. Linear regression on these points shows the slope of the corresponding line is 0.0849 g/day with a correlation coefficient of 0.998.

1. Apparatus useful in determining the permeation rate of liquid organic compounds through polymeric pipes, comprising:
(a) A first flange and a second flange located opposite one another with the polymeric pipe positioned therebetween;
(b) said flanges each having opposing indented surfaces and with gaskets secured within said indented surfaces, such that said gaskets extend partially outside said indented surfaces and said gaskets further engage opposing ends of the polymeric pipe, and further said first and second flanges are secured to the pipe; and
(c) said first flange and associated gasket having an aperture formed therethrough and closure means to accommodate the introduction of liquid organic compounds and retain them within the pipe.

2. The apparatus of claim 1 wherein said gaskets comprise perfluoroelastomer.

3. The apparatus of claim 1 wherein said means to secure said first and second flanges comprises threaded bolts extending through said first flange and received within said second flange.

4. A method for measuring permeation of liquid organic compounds through polymeric pipes comprising:
(a) positioning the polymeric pipe between a first flange and a second flange located opposite one another, said flanges each having opposing indented surfaces and with gaskets secured within said indented surfaces, such that said gaskets extend partially outside said indented surfaces and said gaskets further engage opposing ends of the polymeric pipe;
(b) securing said first and second flanges to the polymeric pipe;
(c) introducing liquid organic compounds through said first flange and associated gasket by means of an aperture formed therethrough into said polymeric pipe in a sufficient quantity to conduct the permeation test;
(d) activating closure means at said aperture to retain the liquid organic compounds within the polymeric pipe; and
(e) measuring the weight of the assembly as described above at various intervals so that weight loss attributed to permeation of the liquid organic compound across the polymeric pipe can be calculated.
